(19) United States
(12) Patent Application Publication
(10) Pub. No.: US 2007/0124955 A1
(43) Pub. Date: Jun. 7, 2007

(54) Air-Flow Sensor System for Clothes Dryer Applications

(75) Inventor: Andrew Crnkovich, Elmhurst, IL (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/564,669

(22) Filed: Nov. 29, 2006

Related U.S. Application Data
(60) Provisional application No. 60/742,079, filed on Dec. 2, 2005.

(51) Int. Cl. F26B 5/04; F26B 19/00; F26B 21/06

(52) U.S. Cl. 34/402; 34/530; 34/547

(57) ABSTRACT

A sensor is installed in the dryer air-stream to verify that an adequate draft is being created by the appliance prior to activating the appliances air-heating system. If the sensor determines that an adequate draft is present, determined, e.g. by a pressure differential in the system, it will allow the appliance's air-heating system (either an electrical element or gas burner) to be activated. If the sensor determines that an inadequate draft is present, this may be symptomatic of a blocked or obstructed air-vent or lint trap, which is a potential hazard. In this case the system will not activate the heating system and an audible and/or visual warning of the failure mode may be displayed.

### CROSS-REFERENCE TO RELATED PATENT APPLICATIONS

This patent application claims the benefit of U.S. Provisional Patent Application No. 60/742,079, filed Dec. 2, 2005, the teachings and disclosure of which are hereby incorporated in their entireties by reference thereto.

### FIELD OF THE INVENTION

This invention generally relates to consumer and commercial appliances, and more particularly to consumer and commercial clothes dryers.

### BACKGROUND OF THE INVENTION

Clothes dryers are a leading cause of residential fires in the United States. In 1998 alone, the National Fire Protection Association (NFPA) reported 15 thousand dryer fires in the United States, resulting in approximately 300 injuries and over $75 million in direct property damage. As a principal initial source of ignition for many of these fires is in the enclosed dryer vent stack, traditional residential smoke alarms may not sound a warning until the fire is in an advanced state because the by-products of the combustion are vented outside the dwelling or structure.

One potential cause for such a fire is a reduced air flow through the dryer due to build up of lint in the exhaust vent, blockage of the vent, etc. Without adequate air flow through the dryer, the likelihood of a fire is increased.

There exists, therefore, a need in the art for a clothes dryer that can sense the likelihood of such a vent fire due to reduced air flow, prevent the occurrence of such a fire and provide adequate warning to the residents of the dwelling of the condition.

The invention provides such a clothes dryer. These and other advantages of the invention, as well as additional inventive features, will be apparent from the description of the invention provided herein.

### BRIEF SUMMARY OF THE INVENTION

In view of the above, an embodiment of the present invention provides a new and improved consumer or commercial appliance that overcomes one or more of the problems existing in the art. More particularly, an embodiment of the present invention provides a new and improved clothes dryer that can detect the possibility of a vent fire and prevent or reduce the likelihood of same.

In one embodiment of the present invention, a system to verify that the dryer vent system has an adequate draft to operate safely is provided. If an inadequate draft is detected, the heating system of the dryer is not enabled, or if such condition occurs during the heating cycle, the heating system is disabled. This could greatly mitigate the number of fires caused by built up lint deposits in the ventilation system.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric illustration of a clothes dryer constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

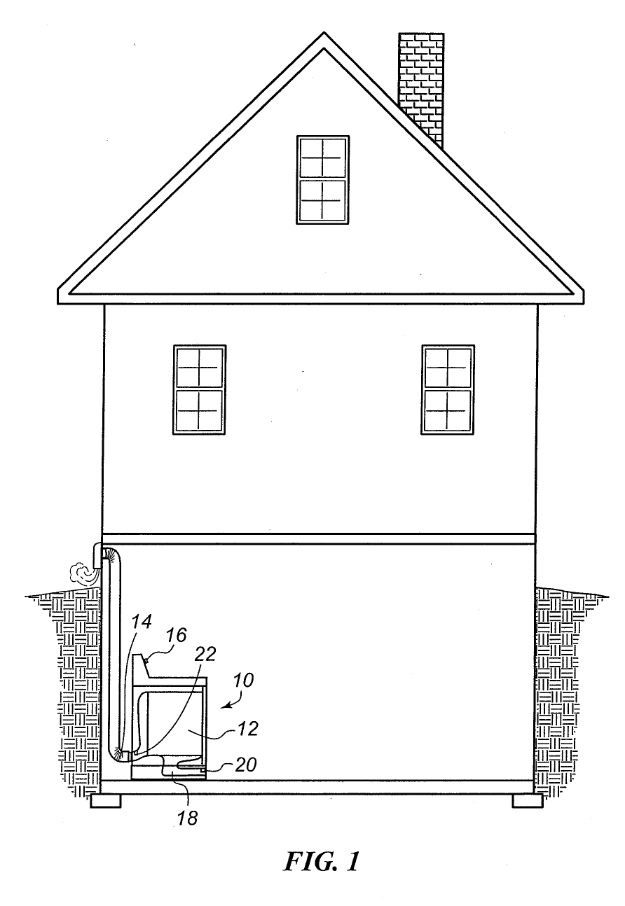

Referring to FIG. 1, a typical dwelling 20 is illustrated having a basement in which is installed a clothes dryer 10 constructed in accordance with the teachings of the present invention. This clothes dryer 10 takes in air via air intake 18, heats the air by a gas flame or an electric heating element, passes the heated air through the dryer drum 12, and then vents the air to the outside of the dwelling via the exhaust vent 14. Assuming that this air path is free of excessive lint build up in the exhaust 14 and is unobstructed in the inlet 18, the operation of the dryer 10 occurs without incident to dry the clothes placed in the drum 12. However, if an adequate supply of air is not able to pass through the system due, e.g., to a build up of lint in the exhaust 14, the likelihood of a fire is increased.

To reduce the likelihood of a fire occurring, the dryer 10 of an embodiment of the present invention monitors the air flow through the dryer 10. If an adequate flow of air cannot be established, or if during operation an adequate flow of air cannot be maintained, the controller for the dryer 10 does not enable, or disables, the heating system.

This monitoring of the air flow may be accomplished by various technology sensors as are known in the art, e.g. flow sensors, pressure sensors, etc. In one embodiment, a pressure sensor is installed in the dryer air-stream to verify that an adequate draft is being created by the dryer prior to activating the dryer's air-heating system. In an alternate embodiment, two pressures sensors 20, 22 are used. If the sensors 20, 22 determine that an adequate draft is present, determined by a pressure differential in the system measured by, in one embodiment, by the input pressure sensor 20 and outlet pressure sensor 22, the system will allow the appliance's air-heating system (either an electrical element or gas burner) to be activated.

If the controller determines that an inadequate draft is present, this may be symptomatic of a blocked or obstructed air-vent or lint trap, which is a potential hazard. In this case the controller will not activate the heating system and an audible and/or visual warning 16 of the failure mode may be displayed. If the inadequate flow is detected during operation of the heating system, the dryer 10 will disable the heating system in one embodiment. The blower of the dryer may also be disabled in one embodiment immediately, after a predetermined period to allow the heating system to cool, or after a monitored temperature of the air stream drops below a temperature threshold.

The sensor could be installed in dryers with either electromechanical controls or electronic controls. In dryers with electromechanical controls the sensor would be part of the circuit to activate the heating system. If no or inadequate draft is present, the dryer 10 would complete its cycle without heat. In dryers with electronic controls, the cycle would stop and a audible and/or visual signal 16 would be issues to alert the operator to the fault condition.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A clothes dryer, comprising:
a housing;
an air inlet and an air outlet in fluid communication with one another through a drum within the housing defining an air-stream therethrough;
a heating system positioned to heat air flowing in the air-stream prior to entering the drum to aid in drying of clothes placed therein;
an air flow sensor positioned in the air-stream to monitor air flow therethrough; and
wherein the heating system is not enabled until the air flow is above a predetermined threshold.

2. The clothes dryer of claim 1, wherein the heating system is disabled when the air flow is below a predetermined threshold.

3. The clothes dryer of claim 2, further comprising a visual indicator positioned on the housing, and wherein the visual indicator is energized when the air flow is below the predetermined threshold.

4. The clothes dryer of claim 2, further comprising an audible alarm, and wherein the audible alarm is energized when the air flow is below the predetermined threshold.

5. The clothes dryer of claim 2, further comprising a blower positioned in the air-stream to cause a flow of air therethrough, and wherein the blower is disabled when the air flow is below the predetermined threshold.

6. The clothes dryer of claim 2, further comprising a blower positioned in the air-stream to cause a flow of air therethrough, and wherein the blower is disabled after a predetermined period when the air flow is below the predetermined threshold.

7. The clothes dryer of claim 2, further comprising a blower positioned in the air-stream to cause a flow of air therethrough, and a temperature sensor positioned downstream of the heating system, and wherein the blower is disabled after a temperature of the air flowing in the air stream drops below a predetermined temperature threshold when the air flow is below the predetermined threshold.

8. The clothes dryer of claim 1, wherein the air flow sensor comprises a pressure sensor.

9. The clothes dryer of claim 1, wherein the air flow sensor comprises an inlet pressure sensor positioned in proximity to the air inlet, and an outlet pressure sensor positioned in proximity to the air outlet.

10. A clothes dryer, comprising:
a housing;
an air inlet and an air outlet in fluid communication with one another through a drum within the housing defining an air-stream therethrough;
a heating system positioned to heat air flowing in the air-stream prior to entering the drum to aid in drying of clothes placed therein;
an air flow sensor positioned in the air-stream to monitor air flow therethrough; and
wherein the heating system is disabled when the air flow is below a predetermined threshold.

11. The clothes dryer of claim 10, further comprising a visual indicator positioned on the housing, and wherein the visual indicator is energized when the air flow is below the predetermined threshold.

12. The clothes dryer of claim 10, further comprising an audible alarm, and wherein the audible alarm is energized when the air flow is below the predetermined threshold.

13. The clothes dryer of claim 10, further comprising a blower positioned in the air-stream to cause a flow of air therethrough, and wherein the blower is disabled when the air flow is below the predetermined threshold.

14. The clothes dryer of claim 10, further comprising a blower positioned in the air-stream to cause a flow of air therethrough, and wherein the blower is disabled after a predetermined period when the air flow is below the predetermined threshold.

15. The clothes dryer of claim 10, further comprising a blower positioned in the air-stream to cause a flow of air therethrough, and a temperature sensor positioned downstream of the heating system, and wherein the blower is disabled after a temperature of the air flowing in the air stream drops below a predetermined temperature threshold when the air flow is below the predetermined threshold.

16. The clothes dryer of claim 10, wherein the air flow sensor comprises a pressure sensor.

17. The clothes dryer of claim 10, wherein the air flow sensor comprises an inlet pressure sensor positioned in proximity to the air inlet, and an outlet pressure sensor positioned in proximity to the air outlet.

18. A method of preventing dryer vent fires, comprising the steps of:
monitoring a flow of air though a dryer;
disabling a heating system of the dryer when the step of monitoring indicates that the flow is less than a predetermined threshold.

19. The method of claim 18, further comprising the step of disabling a blower of the dryer after the step of monitoring indicates that the flow is less than the predetermined threshold.

20. The method of claim 18, further comprising the step of providing an indication to a user that the flow is less than the predetermined threshold.
